(19) United States
(12) Patent Application Publication
(10) Pub. No.: US 2024/0321506 A1
(43) Pub. Date: Sep. 26, 2024

(54) COIL DEVICE

(71) Applicant: TDK CORPORATION, Tokyo (JP)

(72) Inventors: Kiho HWANG, Tokyo (JP); Toshiyuki HORIKAWA, Tokyo (JP)

(73) Assignee: TDK CORPORATION, Tokyo (JP)

(21) Appl. No.: 18/608,112

(22) Filed: Mar. 18, 2024

(30) Foreign Application Priority Data
Mar. 20, 2023 (JP) 2023-044373

(51) Int. Cl. H01F 27/28; H01F 27/24; H01F 27/29; H01F 27/32

(52) U.S. Cl. CPC H01F 27/2823; H01F 27/292; H01F 27/325; H01F 27/24

(57) ABSTRACT

A coil device including bobbins, a continuous first wire wound around the bobbins, and a continuous second wire wound around the bobbins. The bobbins include a first bobbin, a second bobbin, and a third bobbin. The first wire is wound around the first bobbin to form a first coil. The second wire is wound around the second bobbin to form a second coil. The first wire is wound around the third bobbin to form a third primary coil and the second wire is wound around the third bobbin to form a third secondary coil.

### BACKGROUND OF THE INVENTION

### 1. Technical Field

The present invention relates to a coil device.

### 2. Description of the Related Art

Conventionally, there is a known technique to form an electric circuit by connecting coil devices to each other. In addition, there is a known technique to form an electric circuit by connecting coils of a coil device to each other (for example, JP H5-43734 U).

However, all of the above-described techniques have a problem of complicated wire routing between coil devices or between coils. In addition, since a terminal or the like must be used to connect coil devices or coils, electrical properties (copper loss or the like) deteriorate in each coil due to the connection resistance of the terminal or the like.

### CITATION LIST

### Patent Literature

Patent Literature 1: JP H5-43734 U

### SUMMARY OF THE INVENTION

The present invention has been made in view of such circumstances, and an object thereof is to provide a coil device having simple wire routing and excellent electrical properties.

In order to achieve the above object, a coil device according to the present invention includes
Bobbins,
a continuous first wire wound around the bobbins,
a continuous second wire wound around the bobbins,
the bobbins includes a first bobbin, a second bobbin, and a third bobbin,
the first wire is wound around the first bobbin to form a first coil,
the second wire is wound around the second bobbin to form a second coil, and
the first wire is wound around the third bobbin to form a third primary coil, and
the second wire is wound around the third bobbin to form a third secondary coil.

In the coil device according to the present invention, both the first wire and the second wire are one continuous wire. Therefore, when the first wire is wound around the first bobbin and the third bobbin to form the first coil and the third primary coil, respectively, the first coil and the third primary coil are continuous, and no discontinuity due to a terminal or the like is formed between the first coil and the third primary coil. This simplifies the first wire routing between the first coil and the third primary coil, and improves the reliability of the coil device. Further, the electrical properties (copper loss and the like) of the first coil or the third primary coil are not deteriorated due to discontinuities such as terminals.

Similarly, when a second wire is wound around the second bobbin and the third bobbin to form the second coil and the third secondary coil, respectively, the second coil and the third secondary coil are continuous, and no discontinuity due to a terminal or the like is formed between the second coil and the third secondary coil. This simplifies the second wire routing between the second coil and the third secondary coil, and improves the reliability of the coil device. Further, the electrical properties (copper loss and the like) of the second coil or the third secondary coil are not deteriorated due to discontinuities such as terminals.

In addition, a first inductor portion can be formed by the first coil formed on the first bobbin, and a second inductor portion can be formed by the second coil formed on the second bobbin. Further, a transformer portion can be formed by the third primary coil and the third secondary coil formed on the third bobbin. Therefore, for example, an electric circuit including two inductor portions and one transformer portion can be configured by two continuous wires.

The third bobbin may be disposed between the first bobbin and the second bobbin, the first wire may be continuously wound from the first bobbin to the third bobbin, and the second wire may be continuously wound from the second bobbin to the third bobbin. By disposing the third bobbin between the first bobbin and the second bobbin, the first wire can be easily wound from the first bobbin to the third bobbin, and the third primary coil can be easily formed on the third bobbin. In addition, the second wire can be easily wound from the second bobbin to the third bobbin, and the third secondary coil can be easily formed on the third bobbin. As a result, a transformer portion can be easily formed on the third bobbin.

One of the third primary coil and the third secondary coil may be stacked on the other of the third primary coil and the third secondary coil. Alternatively, the third primary coil and the third secondary coil may be disposed adjacent to each other along the axial direction of the third bobbin. In this case, the coupling between the third primary coil and the third secondary coil can be easily adjusted, and the magnetic properties of the coil device can be easily optimized.

The bobbins may further include a fourth bobbin, and the first wire may be wound around the fourth bobbin to form a fourth primary coil, and the second wire may be wound around the fourth bobbin to form a fourth secondary coil. In this case, a transformer portion can be formed by the fourth primary coil and the fourth secondary coil formed on the fourth bobbin. Therefore, for example, an electric circuit (resonant circuit or the like) including two inductor portions and two transformer portions can be configured by two continuous wires.

When the first wire is wound around the first bobbin, the third bobbin, and the fourth bobbin to form the first coil, the third primary coil, and the fourth primary coil, respectively, these coils are continuous, and no discontinuity due to a terminal or the like is formed between these coils. Therefore, the first wire is simply routed between these coils, and the reliability of the coil device is improved. Further, the electrical properties (copper loss and the like) of the first coil, the third primary coil, or the fourth primary coil are not deteriorated due to discontinuities such as terminals.

When the second wire is wound around the second bobbin, the fourth bobbin, and the third bobbin to form the second coil, the fourth secondary coil, and the third secondary coil, respectively, these coils are continuous, and no discontinuity due to a terminal or the like is formed between these coils. Therefore, the second wire is simply routed between these coils, and the reliability of the coil device is improved. Further, the electrical properties (copper loss and the like) of the second coil, the fourth secondary coil, or the third secondary coil are not deteriorated due to discontinuities such as terminals.

The third bobbin and the fourth bobbin may be disposed between the first bobbin and the second bobbin, the first wire may be continuously wound around the first bobbin, the third bobbin, and the fourth bobbin in this order, and the second wire may be continuously wound around the second bobbin, the fourth bobbin, and the third bobbin in this order. By arranging the third bobbin and the fourth bobbin between the first bobbin and the second bobbin, the first wire can be easily wound around the first bobbin, the third bobbin, and the fourth bobbin in this order. Further, the second wire can be easily wound around the second bobbin, the fourth bobbin, and the third bobbin in this order. Therefore, the third primary coil can be easily formed on the third bobbin, and the fourth primary coil can be easily formed on the fourth bobbin. Further, the third secondary coil can be easily formed on the third bobbin, and the fourth secondary coil can be easily formed on the fourth bobbin. As a result, a transformer portion can be easily formed on each of the third bobbin and the fourth bobbin.

(1) When the third secondary coil is stacked on the third primary coil on the third bobbin, the fourth secondary coil may be stacked on the fourth primary coil on the fourth bobbin, and (2) when the third primary coil is stacked on the third secondary coil on the third bobbin, the fourth primary coil may be stacked on the fourth secondary coil on the fourth bobbin. In the aspect (1), first, the first wire can be continuously wound around the first bobbin, the third bobbin, and the fourth bobbin in this order, and then the second wire can be continuously wound around the second bobbin, the fourth bobbin, and the third bobbin in this order. Therefore, the winding operation of the first and second wires is easy. In the aspect (2), first, the second wire can be continuously wound around the second bobbin, the fourth bobbin, and the third bobbin in this order, and then the first wire can be continuously wound around the first bobbin, the third bobbin, and the fourth bobbin in this order. Therefore, the winding operation of the first and second wires is easy.

The third secondary coil may be stacked on the third primary coil on the third bobbin, and the fourth primary coil may be stacked on top the fourth secondary coil on the fourth bobbin. Such a configuration is formed, for example, by winding the first and second wires in the following manner. That is, first, the first wire is wound around the first bobbin and the third bobbin in this order to form the first coil and the third primary coil, respectively. Further, the second wire is wound around the second bobbin and the fourth bobbin in this order to form the second coil and the fourth secondary coil, respectively. Next, the first wire is wound around the fourth bobbin on the fourth secondary coil to form the fourth primary coil. Further, the second wire is wound around the third bobbin on the third primary coil to form the third secondary coil. Winding the first and second wires in this manner enables simultaneous winding of the first and second wires and speeds up the winding operation of the first wire and the second wire.

The third primary coil and the third secondary coil may be disposed adjacent to each other along the axial direction of the third bobbin, and the fourth primary coil and the fourth secondary coil may be disposed adjacent to each other along the axial direction of the fourth bobbin. In this case, the coupling between third primary coil and the third secondary coil, and the coupling between the fourth primary coil and the fourth secondary coil can be easily adjusted, and the magnetic properties of the coil device can be easily optimized.

### BRIEF DESCRIPTION OF THE DRAWINGS

FIG. 1 is a perspective view of a coil device according to a first embodiment of the present invention;

FIG. 2 is a perspective view of bobbins of the coil device illustrated in FIG. 1;

FIG. 3 is a perspective view of the coil device illustrated in FIG. 1, in which the core is omitted;

FIG. 4 is a partially enlarged perspective view of the bobbin illustrated in FIG. 3;

FIG. 5 is a perspective view of the core illustrated in FIG. 1;

FIG. 6 is a perspective view of the first and second wires illustrated in FIG. 3;

FIG. 7 is a perspective view for depicting the method for producing the coil device of the first embodiment;

FIG. 8 is a perspective view of a coil device according to a second embodiment of the present invention;

FIG. 9 is a perspective view of the first wire and the second wire illustrated in FIG. 8;

FIG. 10 is a perspective view for depicting the method for producing the coil device illustrated in FIG. 8;

FIG. 11 is a perspective view of a coil device according to a third embodiment of the present invention;

FIG. 12 is a perspective view of the first and second wires illustrated in FIG. 11;

FIG. 13 is a perspective view for depicting the method for producing the coil device illustrated in FIG. 11;

FIG. 14 is a perspective view of a coil device according to a fourth embodiment of the present invention;

FIG. 15 is a perspective view of the first and second wires illustrated in FIG. 14; and

FIG. 16 is a side view of the coil device illustrated in FIG. 14.

### DETAILED DESCRIPTION

Hereinafter, embodiments of the present invention will be described with reference to the drawings. Note that the illustrated contents are merely schematic and exemplary for understanding the present invention, and the appearance, the dimensional ratio, and the like may be different from the actual ones. Further, the present invention is not limited to the following embodiments.

### First Embodiment

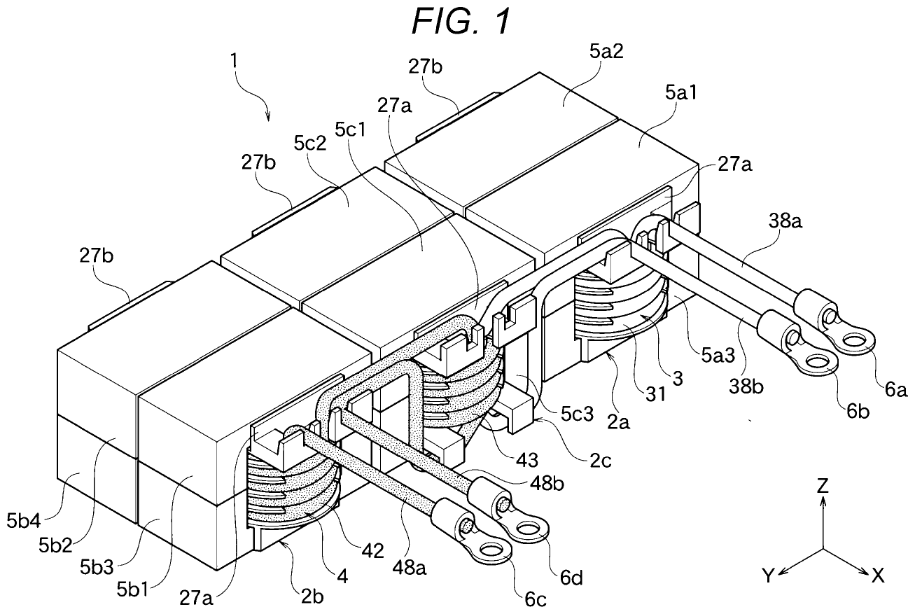

A coil device 1 according to the first embodiment of the present invention illustrated in FIG. 1 functions as, for example, a leakage transformer, and is used in power supply circuits of vehicle chargers and various electric devices. The coil device 1 includes a first wire 3, a second wire 4, a first bobbin 2a, a second bobbin 2b, and a third bobbin 2c. The coil device 1 includes one continuous first wire 3 and one continuous second wire 4 wound around bobbins. The coil device 1 includes, in addition to the above-described components, for example, cores 5a1 to 5a4, cores 5b1 to 5b4, and cores 5c1 to 5c4.

In FIG. 1 and other figures, the X axis is an axis corresponding to the lateral direction of the core 5a1 in a plan view of the core 5a1. The Y axis is an axis corresponding to the longitudinal direction of the core 5a1 in plan view of the core 5al. The Z axis is an axis perpendicular to the X axis and the Y axis. In the following description, for each of the X axis, the Y axis, and the Z axis, the direction toward the center of the coil device 1 is inside and the direction away from the center of the coil device 1 is outside. In addition, the positive side of the Z axis is the upper side, and the negative side is the lower side.

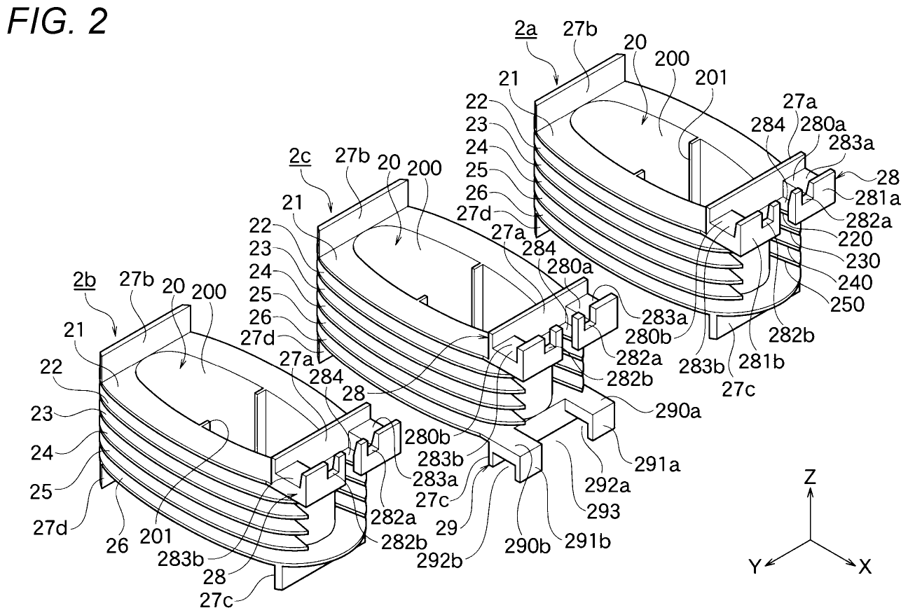

As illustrated in FIG. 2, the first bobbin 2a and the second bobbin 2b have the same shape, and each have a cylindrical portion 20, flange portions 21 to 26, core fixing portions 27a to 27d, and a leadout fixing portion 28. Similarly to the first bobbin 2a and the second bobbin 2b, the third bobbin 2c includes a cylindrical portion 20, flange portions 21 to 26, core fixing portions 27a to 27d, and a leadout fixing portion 28. The third bobbin 2c further includes a wire insertion portion 29 in addition to these components. The third bobbin 2c is disposed between the first bobbin 2a and the second bobbin 2b along the Y axis. The first bobbin 2a to the third bobbin 2c are made of, for example, plastic such as PPS, PET, PBT, or LCP, or other insulating member (for example, a heat-resistant material).

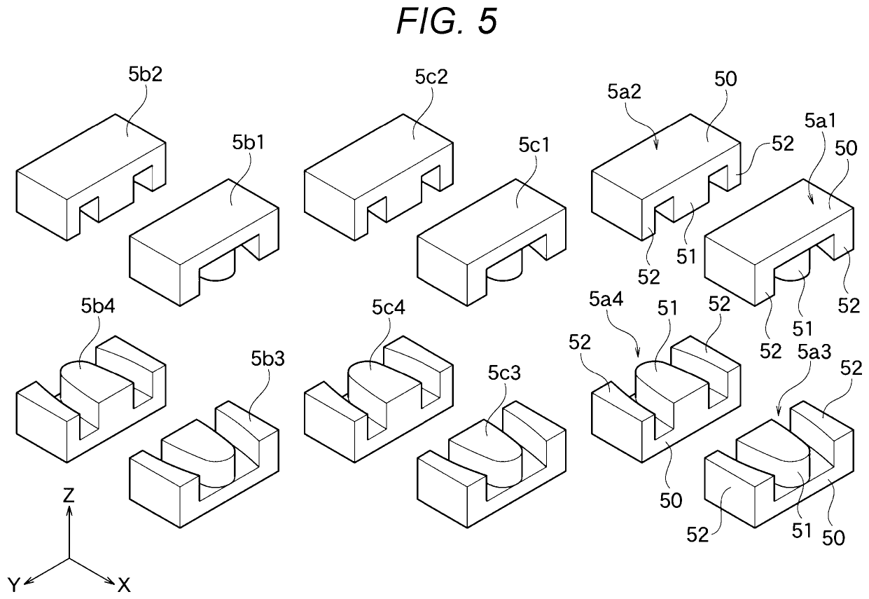

The cylindrical portion 20 is a bottomless cylindrical body, and has a through hole 200 and a projection 201. A portion (middle leg 51) of each of the cores 5a1 to 5a4 illustrated in FIG. 5 is inserted into the through hole 200 of the first bobbin 2a. A portion (middle leg 51) of each of the cores 5b1 to 5b4 illustrated in FIG. 5 is inserted into the through hole 200 of the second bobbin 2b. A portion (middle leg 51) of each of the cores 5cl to 5c4 illustrated in FIG. 5 is inserted into the through hole 200 of the third bobbin 2c. The middle leg 51 of one core and the middle leg 51 of the other core adjacent along the X axis are disposed via the projection 201. The first wire 3 or the second wire 4 is wound around the outer circumferential surface of the cylindrical portion 20. The cross-sectional shape of the cylindrical portion 20 is elliptical, but may be circular or the like.

The flange portion 21 is formed at one end of the cylindrical portion 20 in the Z axis direction, and the flange portion 26 is formed at the other end of the cylindrical portion 20 in the Z axis direction. The flange portions 22 to 25 are located between the flange portion 21 and the flange portion 26, and are disposed at equal intervals along the Z axis. The flange portions 21 to 26 protrude radially outside the outer circumferential surface of the cylindrical portion 20. The length at which the flange portions 21 to 26 protrude radially outward is not particularly limited, but is equal to or greater than the diameter of the first wire 3 or the second wire 4.

A notch portion 220 is formed at one end of the flange portion 22 in the long axis direction (X axis direction). Similarly, a notch portion 230 is formed at one end of the flange portion 23 in the long axis direction. Similarly, a notch portion 240 is formed at one end of the flange portion 24 in the long axis direction. Similarly, a notch portion 250 is formed in the long axis direction of the flange portion 25.

For example, on the first bobbin 2a, the first wire 3 wound around the region between the flange portion 21 and the flange portion 22 can be transferred to the region between the flange portion 22 and the flange portion 23 via the notch portion 220. The first wire 3 wound around the region between the flange portion 22 and the flange portion 23 can be transferred to the region between the flange portion 23 and the flange portion 24 via the notch portion 230. The first wire 3 wound around the region between the flange portion 23 and the flange portion 24 can be transferred to the region between the flange portion 24 and the flange portion 25 via the notch portion 240. The first wire 3 wound around the region between the flange portion 24 and the flange portion 25 can be transferred to the region between the flange portion 25 and the flange portion 26 via the notch portion 250.

The core fixing portions 27a and 27b are formed on the flange portion 21 and protrude from one main surface (upper surface) of the flange portion 21 along the Z axis. The core fixing portion 27a and the core fixing portion 27b are located on opposite sides of each other along the X axis. The core fixing portion 27a is located at one end of the flange portion 21 in the X axis direction, and the core fixing portion 27b is located at the other end of the flange portion 21 in the X axis direction.

The core fixing portions 27c and 27d are formed in the flange portion 26, and protrude along the Z axis from the other main surface (lower surface) of the flange portion 26 in a direction opposite to the core fixing portions 27a and 27b. The core fixing portion 27c and the core fixing portion 27d are located on opposite sides of each other along the X axis. The core fixing portion 27c is located at one end of the flange portion 26 in the X axis direction, and the core fixing portion 27d is located at the other end of the flange portion 26 in the X axis direction.

As illustrated in FIG. 1, for example, on the first bobbin 2a, the cores 5a1 and 5a2 are disposed between the core fixing portion 27a and the core fixing portion 27b. Accordingly, the cores 5a1 and 5a2 are positioned by the core fixing portions 27a and 27b in the X axis direction. Although not illustrated in detail, on the first bobbin 2a, the cores 5a3 and 5a4 illustrated in FIG. 5 are disposed between the core fixing portion 27c and the core fixing portion 27d illustrated in FIG. 2. Accordingly, the cores 5a3 and 5a4 are positioned by the core fixing portions 27c and 27d in the X axis direction.

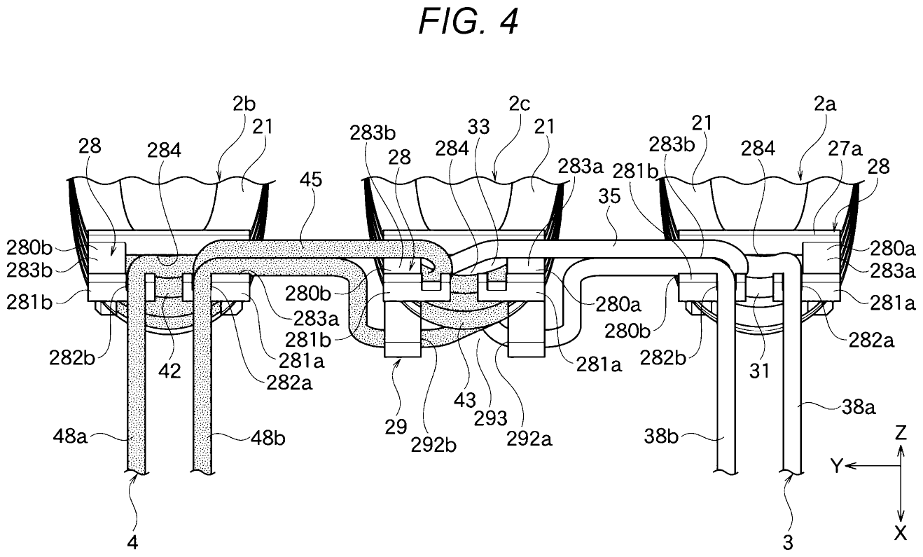

As illustrated in FIG. 2, the leadout fixing portion 28 includes protrusions 280a and 280b, wall portions 281 and 281b, groove portions 282a and 282b, leadout passages 283a and 283b, and a space 284. As illustrated in FIG. 4, the protrusions 280a and 280b protrude outward from one end of the flange portion 21 along the X axis. Each of the protrusions 280a and 280b is a rectangular parallelepiped plate body having a predetermined thickness along the Z axis. The shape of each of the protrusions 280a and 280b is rectangular in plan view. As illustrated in FIG. 2, the position of the upper surface of each of the protrusions 280a and 280b is located at a position higher than the position of the upper surface of the flange portion 21. The protrusion 280a and the protrusion 280b face each other along the Y axis, and the space 284 is formed between the protrusion 280a and the protrusion 280b.

The wall portion 281a is formed at an outer end of the protrusion 280a in the X axis direction. The wall portion 281a protrudes in the same direction as the core fixing portion 27a along the Z axis so as to be orthogonal to the protrusion 280a. The wall portion 281b is formed at an outer end of the protrusion 280b in the X axis direction. The wall portion 281b protrudes in the same direction as the core fixing portion 27a along the Z axis so as to be orthogonal to the protrusion 280b. The wall portion 281a and the wall portion 281b face each other along the Y axis, and a gap is formed between the wall portion 281a and the wall portion 281b.

The groove portion 282a is formed in the wall portion 281a, and extends from one end to the other end of the wall portion 281a in the Z axis direction. The groove portion 282b is formed in the wall portion 281b, and extends from one end to the other end of the wall portion 281b in the Z axis direction. The depth of each of the groove portions 282a and 282b is not particularly limited, but is equal to or greater than the diameter of the first wire 3 or the second wire 4.

The leadout passage 283a is a passage defined by the protrusion 280a, the wall portion 281a, and the core fixing portion 27a, and extends along the Y axis. The leadout passage 283a is sandwiched between the wall portion 281a and the core fixing portion 27a in the X axis direction. The leadout passage 283b is a passage defined by the protrusion 280b, the wall portion 281b, and the core fixing portion 27a, and extends along the Y axis. The leadout passage 283b is sandwiched between the wall portion 281b and the core fixing portion 27a in the X axis direction. At least one of the first wire 3 and the second wire 4 can pass through the leadout passages 283a and 283b.

As described above, the position of the upper surface of each of the protrusions 280a and 280b is located at a position higher than the position of the upper surface of the flange portion 21. Therefore, the leadout passages 283a and 283b are located at positions higher than the position of the upper surface of the flange portion 21. Therefore, the first wire 3 passing through the leadout passage 283a or 283b passes above the upper surface of the flange portion 21. In addition, the second wire 4 passing through the leadout passage 283a or 283b passes above the upper surface of the flange portion 21. However, the positions through which the first wire 3 and/or the second wire 4 in the leadout passages 283a and 283b are not particularly limited.

As illustrated in FIG. 4, the space 284 is formed between the core fixing portion 27a and the wall portions 281a and 281b in the X axis direction. In addition, the space 284 is formed between the protrusion 280a and the protrusion 280b in the Y axis direction. The space 284 is a space partially surrounded by the core fixing portion 27a, the wall portions 281a and 281b, and the protrusions 280a and 280b. The space 284 extends so as to penetrate the leadout fixing portion 28 along the Z axis. The space 284 guides the first wire 3 or the second wire 4 to a region between the flange portion 21 and the flange portion 22.

As illustrated in FIG. 2, the wire insertion portion 29 has protrusions 290a and 290b, wall portions 291a and 291b, leadout passages 292a and 292b, and a space 293. The protrusions 290a and 290b are disposed so as to face the protrusions 280a and 280b, respectively, along the Z axis. The protrusions 290a and 290b protrude outward from one end of the flange portion 26 along the X axis. Each of the protrusions 290a and 290b is a rectangular parallelepiped plate body having a predetermined thickness along the Z axis. The shape of each of the protrusions 290a and 290b is rectangular in plan view. The position of the lower surface of each of the protrusions 290a and 290b is located at a position lower than the position of the lower surface of the flange portion 26. The protrusion 290a and the protrusion 290b face each other along the Y axis, and the space 293 is formed between the protrusion 290a and the protrusion 290b.

The wall portion 291a is formed at an outer end of the protrusion 290a in the X axis direction. The wall portion 291a protrudes in the same direction as the core fixing portion 27c along the Z axis so as to be orthogonal to the protrusion 290a. The wall portion 291b is formed at an outer end of the protrusion 290b in the X axis direction. The wall portion 291b protrudes in the same direction as the core fixing portion 27c along the Z axis so as to be orthogonal to the protrusion 290b. The wall portion 291a and the wall portion 291b face each other along the Y axis, and a gap is formed between the wall portion 291a and the wall portion 291b.

The leadout passage 292a is a passage defined by the protrusion 290a, the wall portion 291a, and the core fixing portion 27c, and extends along the Y axis. The leadout passage 292a is sandwiched between the wall portion 291a and the core fixing portion 27c in the X axis direction. The leadout passage 292b is a passage defined by the protrusion 290b, the wall portion 291b, and the core fixing portion 27c, and extends along the Y axis. The leadout passage 292b is sandwiched between the wall portion 291b and the core fixing portion 27c in the X axis direction. At least one of the first wire 3 and the second wire 4 can pass through the leadout passages 292a and 292b.

As described above, the position of the lower surface of each of the protrusions 290a and 290b is located at a position lower than the position of the lower surface of the flange portion 26. Therefore, the leadout passages 292a and 292b are located at positions lower than the position of the lower surface of the flange portion 26. Therefore, the first wire 3 passing through the leadout passage 292a or 292b passes below the lower surface of the flange portion 26. In addition, the second wire 4 passing through the leadout passage 292a or 292b passes below the lower surface of the flange portion 26. However, the positions through which the first wire 3 and/or the second wire 4 in the leadout passages 292a and 292b are not particularly limited.

As illustrated in FIG. 5, the cores 5a1 to 5a4, the cores 5b1 to 5b4, and the cores 5cl to 5c4 have the same shape. The cores 5a1 to 5a4 are attached to the first bobbin 2a (FIG. 2). The cores 5b1 to 5b4 are attached to the second bobbin 2b (FIG. 2). The cores 5cl to 5c4 are attached to the third bobbin 2c (FIG. 2). Hereinafter, the configuration of each of the cores will be described by taking the core 5a1 as an example. The core 5a1 is an E-shaped core, and has a base portion 50, a middle leg 51, and a pair of outer legs 52. The material of the core 5a1 is, for example, metal or a magnetic material such as ferrite.

The base portion 50 is a flat plate body (cuboid) having a rectangular shape in plan view. The pair of outer legs 52 protrudes from one main surface of the base portion 50 along the Z axis. One outer leg 52 is formed at one end of the base portion 50 in the Y axis direction, and the other outer leg 52 is formed at the other end of the base portion 50 in the Y axis direction. The inner surface of the outer leg 52 (a surface facing an outer circumferential surface of the middle leg 51) extends (curves) along the outer circumferential surface of the middle leg 51.

The middle leg 51 is located between the pair of outer legs 52. The middle leg 51 protrudes from one main surface of the base portion 50 along the Z axis in the same direction as the outer leg 52. The transverse cross-sectional shape of the middle leg 51 (the cross-sectional shape perpendicular to the axial direction of the middle leg 51) is a semi-elliptical shape, but may be a semicircular shape, a polygonal shape, or the like. The middle leg 51 is inserted into the through hole 200 of the first bobbin 2a (the second bobbin 2b or the third bobbin 2c) illustrated in FIG. 2.

The core 5a1 and the core 5a2 are disposed adjacent to each other so as to face each other along the X axis. A gap is formed between the core 5a1 and the core 5a2 along the X axis (see FIG. 1). The core 5a3 and the core 5a4 are disposed adjacent to each other so as to face each other along the X axis. A gap is formed between the core 5a3 and the core 5a4 along the X axis (see FIG. 1).

The core 5a1 and the core 5a3 are disposed adjacent to each other so as to face each other along the Z axis. For example, a gap may be formed along the Z axis between the middle leg 51 (or the outer leg 52) of the core 5a1 and the middle leg 51 (or the outer leg 52) of the core 5a3. The core 5a2 and the core 5a4 are disposed adjacent to each other so as to face each other along the Z axis. For example, a gap may be formed along the Z axis between the middle leg 51 (or the outer leg 52) of the core 5a2 and the middle leg 51 (or the outer leg 52) of the core 5a4.

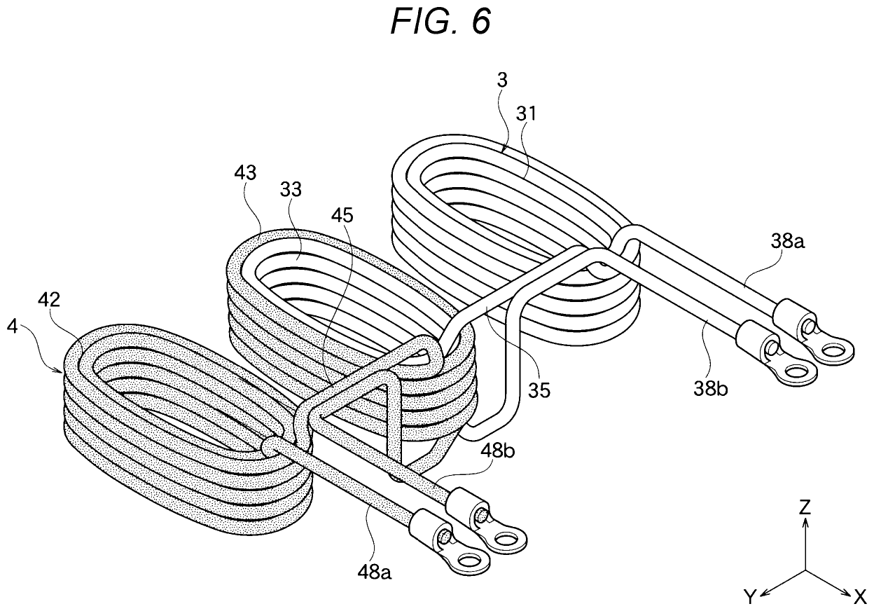

As illustrated in FIG. 6, the first wire 3 has a first coil 31, a third primary coil 33, a connection 35, and first leadout portions 38a and 38b. The second wire 4 has a second coil 42, a third secondary coil 43, a connection 45, and second leadout portions 48a and 48b.

Each of the first wire 3 and the second wire 4 is one continuous wire. Each of the first wire 3 and the second wire 4 is a conductive core wire such as a round wire, a flat wire, a stranded wire, a litz wire, or a braided wire made of, for example, copper. The first wire 3 and the second wire 4 may be insulated coated wires in which these conductive core wires are coated with an insulating coating. The diameter of each of the first wire 3 and the second wire 4 is, for example, 1.0 to 3.0 mm. The diameters of the first wire 3 and the second wire 4 may be equal to each other or may be different from each other. For example, the diameter of one of the first wire 3 and the second wire 4 through which a larger amount of current flows may be made larger than the diameter of the other wire.

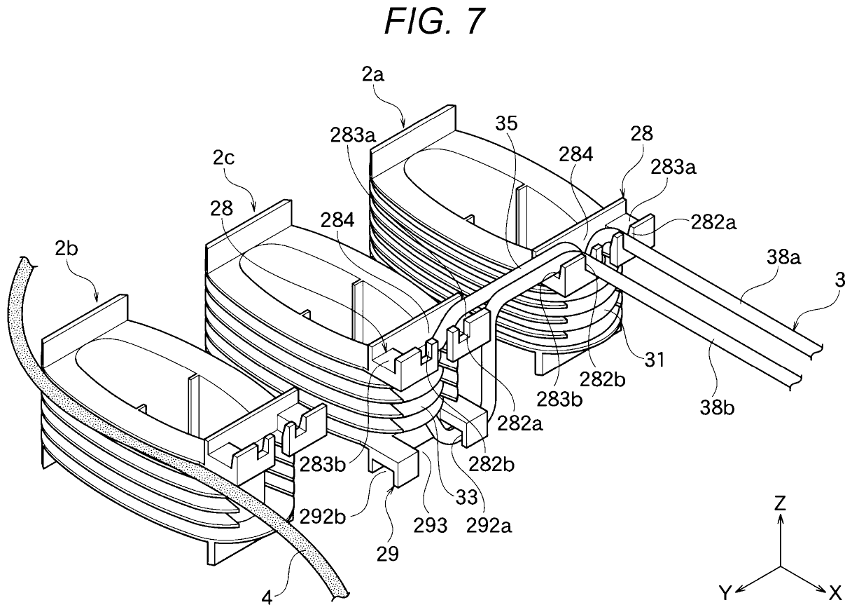

As illustrated in FIG. 7, the first wire 3 is wound around the first bobbin 2a to form the first coil 31. The first coil 31 is not particularly limited, but is formed in five layers along its winding axis direction. In addition, the first coil 31 is not particularly limited, but is formed in two layers along its radial direction (see FIG. 6). The first coil 31 functions as an inductor portion of the coil device 1.

The first wire 3 is wound around the third bobbin 2c to form the third primary coil 33. The third primary coil 33 is not particularly limited, but is formed in five layers along its winding axis direction. In addition, the third primary coil 33 is not particularly limited, but is formed in one layer along its radial direction (see FIG. 6). The third primary coil 33 constitutes a primary coil of a transformer formed on the third bobbin 2c, and functions as a transformer portion of the coil device 1.

On the first bobbin 2a, the first wire 3 is wound from the upper end of the first bobbin 2a, that is, the region between the flange portion 21 and the flange portion 22. The first wire 3 is then wound around the outer circumferential surface of the cylindrical portion 20 from the upper end toward the lower end of the first bobbin 2a. Furthermore, the first wire 3 is wound around the outer circumferential surface of the cylindrical portion 20 from the lower end portion toward the upper end portion of the first bobbin 2a. Thus, the first coil 31 including two layers is formed on the first bobbin 2a along its radial direction (see FIG. 6).

On the third bobbin 2c, the first wire 3 is wound from the upper end of the third bobbin 2c, that is, the region between the flange portion 21 and the flange portion 22. The first wire 3 is then wound around the outer circumferential surface of the cylindrical portion 20 from the upper end toward the lower end of the third bobbin 2c. As a result, the third primary coil 33 including one layer is formed on the third bobbin 2c along its radial direction (see FIG. 6).

In this manner, the first wire 3 is continuously wound from the first bobbin 2a to the third bobbin 2c. Therefore, there is no discontinuity between the first coil 31 and the third primary coil 33. As described above, since the third bobbin 2c is disposed between the first bobbin 2a and the second bobbin 2b, the first wire 3 can be easily wound from the first bobbin 2a to the third bobbin 2c to form the third primary coil 33 on the third bobbin 2c.

The connection 35 continuously connects one end (upper end) of the first coil 31 in the axial direction and one end (upper end) of the third primary coil 33 in the axial direction. As illustrated in FIG. 4, the connection 35 is raised from the outer circumferential surface of the upper end (uppermost layer turn) of the first coil 31 located between the flange portion 21 and the flange portion 22 while passing through the space 284 of the leadout fixing portion 28 on the first bobbin 2a. That is, the connection 35 is drawn out from the upper end (uppermost layer turn) of the first coil 31 to a position higher than this (or a position higher than the upper surface of the flange portion 21).

The connection 35 passes through the leadout passage 283b of the first bobbin 2a along the Y axis and passes through the leadout passage 283a of the third bobbin 2c along the Y axis. That is, the connection 35 passes through a position higher than the upper end portion (uppermost layer turn) of the first coil 31 and the upper end portion (uppermost layer turn) of the third primary coil 33 (or a position higher than the upper surface of the flange portion 21) along the Y axis. The connection 35 is linearly drawn out along the Y axis between the leadout passage 283b of the first bobbin 2a and the leadout passage 283a of the third bobbin 2c, but may be bent or curved in the middle.

On the third bobbin 2c, the connection 35 descends toward the outer circumferential surface of the upper end (uppermost layer turn) of the third primary coil 33 located between the flange portion 21 and the flange portion 22 while passing through the space 284 of the leadout fixing portion 28. That is, the connection 35 descends from a position higher than the upper end (uppermost layer turn) of the third primary coil 33 (or a position higher the upper surface of the flange portion 21) toward the upper end (uppermost layer turn) of the third primary coil 33.

The first leadout portion 38a is a portion between one end of the first wire 3 and the outer circumferential surface of the first coil 31. The first leadout portion 38b is a portion between the other end of the first wire 3 and the third primary coil 33. The first leadout portion 38a is raised from the outer circumferential surface of the first coil 31 while passing through the space 284 of the leadout fixing portion 28 on the first bobbin 2a. The first leadout portion 38a is drawn outward along the X axis from the leadout fixing portion 28 while passing through the groove portion 282a of the leadout fixing portion 28.

On the third bobbin 2c, the first leadout portion 38b is drawn out so as to descend from the outer circumferential surface of the lower end portion (lowermost layer turn) of the third primary coil 33 located between the flange portion 25 and the flange portion 26 while passing through the space 293 of the wire insertion portion 29. That is, the first leadout portion 38b is drawn out from the lower end (lowermost layer turn) of the third primary coil 33 to a position lower than this (or a position lower than the lower surface of the flange portion 26).

Between the third bobbin 2c and the first bobbin 2a, the first leadout portion 38b passes through the leadout passage 292a of the third bobbin 2c along the Y axis, is raised from the leadout passage 292a of the third bobbin 2c toward the leadout passage 283b of the first bobbin 2a, and passes through the leadout passage 283b of the first bobbin 2a along the Y axis. That is, the first leadout portion 38b passes a position lower than the lower end (lowermost layer turn) of the third primary coil 33 (or a position lower than the lower surface of the flange portion 26) along the Y axis, and passes a position higher than the upper end (uppermost layer turn) of the first coil 31 (or a position higher than the upper surface of the flange portion 21) along the Y axis.

The first leadout portion 38b is bent in the leadout passage 283b of the first bobbin 2a, passes through the groove portion 282b of the leadout fixing portion 28, and is drawn out from the leadout fixing portion 28 along the X axis in the same direction as the first leadout portion 38a.

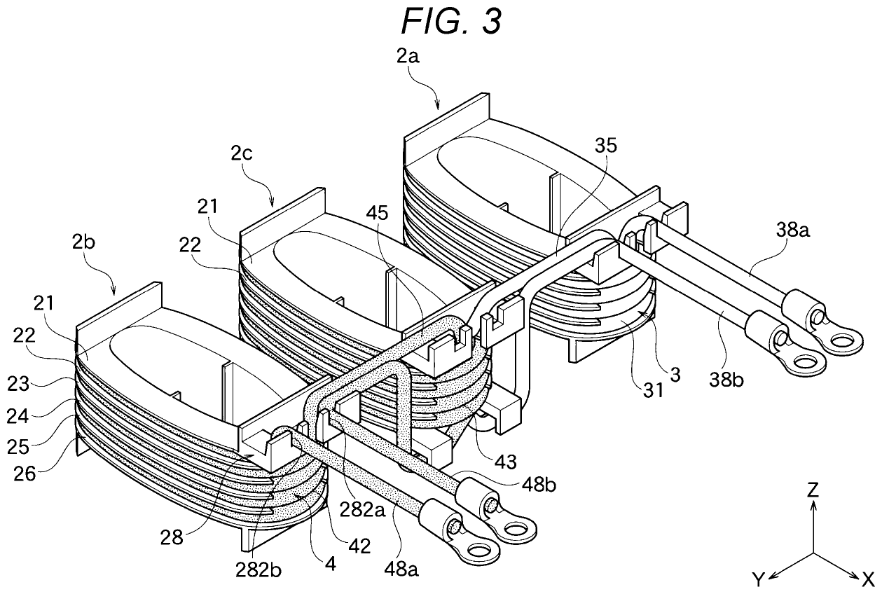

As illustrated in FIG. 3, the second wire 4 is wound around the second bobbin 2b to form the second coil 42. The second coil 42 is not particularly limited, but is formed in five layers along its winding axis direction. In addition, the second coil 42 is not particularly limited, but is formed in two layers along its radial direction (see FIG. 6). The second coil 42 functions as an inductor portion of the coil device 1.

The second wire 4 is wound around the third bobbin 2c, and the third secondary coil 43 is formed on the third primary coil 33 (FIG. 7). The third secondary coil 43 is not particularly limited, but is formed in five layers along its winding axis direction. In addition, the third secondary coil 43 is not particularly limited, but is formed in one layer along its radial direction (see FIG. 6). The third secondary coil 43 constitutes a secondary coil of a transformer formed on the third bobbin 2c, and functions as a transformer portion of the coil device 1. The winding ratio between the third primary coil 33 and the third secondary coil 43 is 1:1.

On the second bobbin 2b, the second wire 4 is wound from the upper end of the second bobbin 2b, that is, the region between the flange portion 21 and the flange portion 22. The second wire 4 is then wound around the outer circumferential surface of the cylindrical portion 20 from the upper end toward the lower end of the second bobbin 2b. Furthermore, the second wire 4 is wound around the outer circumferential surface of the cylindrical portion 20 from the lower end toward the upper end of the second bobbin 2b. Thus, the second coil 42 including two layers is formed on the second bobbin 2b along its radial direction (see FIG. 6).

On the third bobbin 2c, the second wire 4 is wound from the upper end of the third bobbin 2c, that is, the region between the flange portion 21 and the flange portion 22. The second wire 4 is then wound around the outer circumferential surface of the cylindrical portion 20 from the upper end toward the lower end of the third bobbin 2c. As a result, on the third bobbin 2c, the third secondary coil 43 including one layer is formed on the third primary coil 33 along its radial direction, (see FIG. 6).

In this manner, the second wire 4 is continuously wound from the second bobbin 2b to the third bobbin 2c. Therefore, there is no discontinuity between the second coil 42 and the third secondary coil 43. As described above, since the third bobbin 2c is disposed between the first bobbin 2a and the second bobbin 2b, the second wire 4 can be easily wound from the second bobbin 2b to the third bobbin 2c to form the third secondary coil 43 on the third bobbin 2c. Thus, the transformer including the third primary coil 33 and the third secondary coil 43 can be easily formed on the third bobbin 2c.

The connection 45 continuously connects one end (upper end) of the second coil 42 in the axial direction and one end (upper end) of the third secondary coil 43 in the axial direction. As illustrated in FIG. 4, the connection 45 is raised from the outer circumferential surface of the upper end (uppermost layer turn) of the second coil 42 located between the flange portion 21 and the flange portion 22 while passing through the space 284 of the leadout fixing portion 28 on the second bobbin 2b. That is, the connection 45 is drawn out from the upper end (uppermost layer turn) of the second coil 42 to a position higher than this (or a position higher than the upper surface of the flange portion 21).

The connection 45 passes through the leadout passage 283a of the second bobbin 2b along the Y axis and passes through the leadout passage 283b of the third bobbin 2c along the Y axis between the second coil 42 and the third secondary coil 43. That is, the connection 45 passes through a position higher than the upper end portion (uppermost layer turn) of the second coil 42 and the upper end portion (uppermost layer turn) of the third secondary coil 43 (or a position higher than the upper surface of the flange portion 21) along the Y axis. The connection 45 is linearly drawn out along the Y axis between the leadout passage 283a of the second bobbin 2b and the leadout passage 283b of the third bobbin 2c, but may be bent or curved in the middle.

On the third bobbin 2c, the connection 45 descends toward the outer circumferential surface of the upper end (uppermost layer turn) of the third secondary coil 43 located between the flange portion 21 and the flange portion 22 while passing through the space 284 of the leadout fixing portion 28. That is, the connection 45 descends from a position higher than the upper end (uppermost layer turn) of the third secondary coil 43 (or a position higher the upper surface of the flange portion 21) toward the upper end (uppermost layer turn) of the third secondary coil 43.

The second leadout portion 48a is a portion between one end of the second wire 4 and the outer circumferential surface of the second coil 42. The second leadout portion 48b is a portion between the other end of the second wire 4 and the third secondary coil 43. The second leadout portion 48a is raised from the outer circumferential surface of the second coil 42 while passing through the space 284 of the leadout fixing portion 28 on the second bobbin 2b. The second leadout portion 48a is then drawn outward along the X axis from the leadout fixing portion 28 while passing through the groove portion 282b of the leadout fixing portion 28.

On the third bobbin 2c, the second leadout portion 48b is drawn out so as to descend from the outer circumferential surface of the lower end portion (lowermost layer turn) of the third secondary coil 43 located between the flange portion 25 and the flange portion 26 while passing through the space 293 of the wire insertion portion 29. That is, the second leadout portion 48b is drawn out from the lower end (lowermost layer turn) of the third secondary coil 43 to a position lower than this (or a position lower than the lower surface of the flange portion 26).

The second leadout portion 48b passes through the leadout passage 292b of the third bobbin 2c along the Y axis, is raised from the leadout passage 292b of the third bobbin 2c toward the leadout passage 283a of the second bobbin 2b, and passes through the leadout passage 283a of the second bobbin 2b along the Y axis. That is, the second leadout portion 48b passes a position lower than the lower end (lowermost layer turn) of the third secondary coil 43 (or a position lower than the lower surface of the flange portion 26) along the Y axis, and passes a position higher than the upper end (uppermost layer turn) of the second coil 42 (or a position higher than the upper surface of the flange portion 21) along the Y axis.

The second leadout portion 48b is bent in the leadout passage 283a of the second bobbin 2b, passes through the groove portion 282a of the leadout fixing portion 28, and is drawn out from the leadout fixing portion 28 along the X axis in the same direction as the second leadout portion 48a.

As illustrated in FIG. 1, a terminal 6a is attached to the tip of the first leadout portion 38a, and a terminal 6b is attached to the tip of the first leadout portion 38b. Further, a terminal 6c is attached to the tip of the second leadout portion 48a, and a terminal 6d is attached to the tip of the second leadout portion 48b.

Next, the method for producing the coil device 1 is described. First, the members illustrated in FIG. 1 are prepared. Next, as illustrated in FIG. 7, the first wire 3 is wound around the first bobbin 2a so as to reciprocate from the upper side to the lower side, and further from the lower side to the upper side. Thus, the first coil 31 is formed on the first bobbin 2a. The first wire 3 (first leadout portion 38a) is drawn out outward in the X axis direction from the leadout fixing portion 28 through the groove portion 282a of the first bobbin 2a.

Next, the first wire 3 (connection portion 35) is transferred from the first bobbin 2a to the third bobbin 2c, and the first wire 3 is wound around the third bobbin 2c from the upper side to the lower side. As a result, the third primary coil 33 is formed on the third bobbin 2c. Next, the first wire 3 (first leadout portion 38b) is drawn out from the third bobbin 2c to the first bobbin 2a, and further, the first wire 3 (first leadout portion 38b) is drawn out outward in the X axis direction from the leadout fixing portion 28 through the groove portion 282b of the first bobbin 2a.

Next, as illustrated in FIG. 3, the second wire 4 is wound around the second bobbin 2b so as to reciprocate from the upper side to the lower side, and further from the lower side to the upper side. Thus, the second coil 42 is formed on the second bobbin 2b. The second wire 4 (second leadout portion 48a) is drawn out outward in the X axis direction from the leadout fixing portion 28 through the groove portion 282b of the second bobbin 2b.

Next, the second wire 4 (connection portion 45) is transferred from the second bobbin 2b to the third bobbin 2c, and the second wire 4 is wound around the third bobbin 2c from the upper side to the lower side. This forms the third secondary coil 43 on the third primary coil 33 (FIG. 7) on the third bobbin 2c. Next, the second wire 4 (second leadout portion 48b) is drawn out from the third bobbin 2c to the second bobbin 2b, and further, the second wire 4 (second leadout portion 48b) is drawn out outward in the X axis direction from the leadout fixing portion 28 through the groove portion 282a of the second bobbin 2b.

Next, the cores 5a1 to 5 a4, the cores 5 b1 to 5b4, and the cores 5cl to 5c4 illustrated in FIG. 5 are attached to the bobbins 2a to 2c. As illustrated in FIG. 1, the terminals 6a and 6b are attached to the first leadout portions 38a and 38b, respectively, and the terminals 6c and 6d are attached to the second leadout portions 48a and 48b, respectively. The coil device 1 can be produced as described above.

As illustrated in FIG. 6, in the present embodiment, the first coil 31 is wound clockwise, and the third primary coil 33 is wound clockwise. The second coil 42 is wound counterclockwise, and the third secondary coil 43 is wound clockwise. However, the winding direction of these coils is not limited to the winding direction illustrated in FIG. 6.

As described above, in the present embodiment, as illustrated in FIGS. 3 and 6, both the first wire 3 and the second wire 4 are one continuous wire. Therefore, when the first wire 3 is wound around the first bobbin 2a and the third bobbin 2c to form the first coil 31 and the third primary coil 33, respectively, the first coil 31 and the third primary coil 33 are continuous, and no discontinuity due to a terminal or the like is formed between the first coil 31 and the third primary coil 33. Therefore, the first wire 3 is simply routed between the first coil 31 and the third primary coil 33, and the reliability of the coil device 1 is improved. Further, the electrical properties (copper loss and the like) of the first coil 31 or the third primary coil 33 are not deteriorated due to discontinuities such as terminals. Furthermore, the terminal or the like does not come into contact with the core 5a1 or the like, and insulation can be favorably achieved.

Similarly, when the second wire 4 is wound around the second bobbin 2b and the third bobbin 2c to form the second coil 42 and the third secondary coil 43, respectively, the second coil 42 and the third secondary coil 43 are continuous, and no discontinuity due to a terminal or the like is formed between the second coil 42 and the third secondary coil 43. Therefore, the second wire 4 is simply routed between the second coil 42 and the third secondary coil 43, and the reliability of the coil device 1 is improved. Further, the electrical properties (copper loss and the like) of the second coil 42 or the third secondary coil 43 are not deteriorated due to discontinuities such as terminals.

In addition, a first inductor portion can be formed by the first coil 31 formed on the first bobbin 2a, and a second inductor portion can be formed by the second coil 42 formed on the second bobbin 2b. Further, a transformer portion can be formed by the third primary coil 33 and the third secondary coil 43 formed on the third bobbin 2c. Therefore, for example, an electric circuit including two inductor portions and one transformer portion can be configured by two continuous wires.

In addition, since the third secondary coil 43 is disposed (stacked) on the third primary coil 33, the coupling between the third primary coil 33 and the third secondary coil 43 can be easily adjusted, and the magnetic properties of the coil device 1 can be easily optimized.

### Second Embodiment

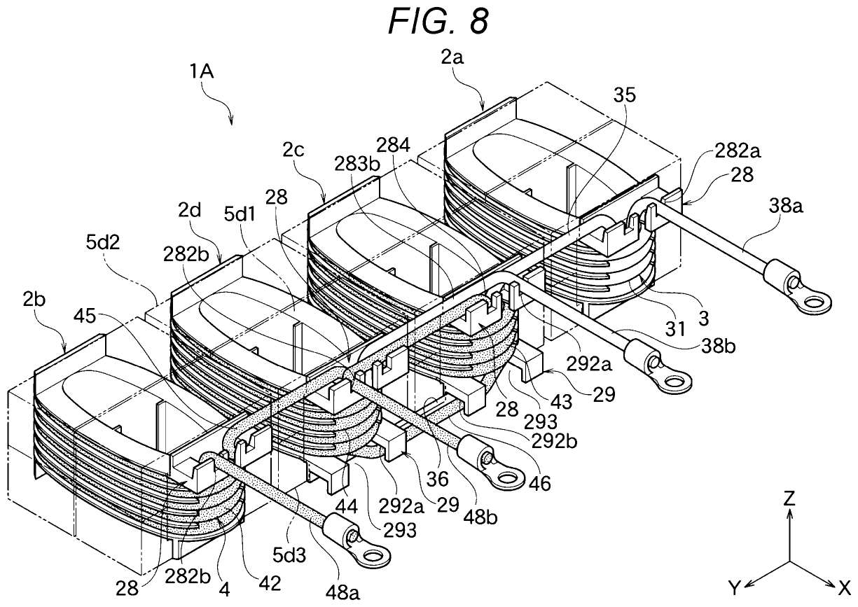

The coil device 1A of the second embodiment illustrated in FIG. 8 has the same configuration as that of the coil device 1 of the first embodiment except for the following points. Portions overlapping with the coil device 1 of the first embodiment are denoted by the same reference numerals, and their detailed description is omitted.

The coil device 1A includes a fourth bobbin 2d in addition to the first bobbin 2a, the second bobbin 2b, and the third bobbin 2c. The coil device 1A includes cores attached to the fourth bobbin 2d in addition to the cores 5a1 to 5a4, the cores 5b1 to 5b4, and the cores 5cl to 5c4 illustrated in FIG. 5. FIG. 8 illustrates only the cores 5d1 to 5d3 as the cores attached to the fourth bobbin 2d.

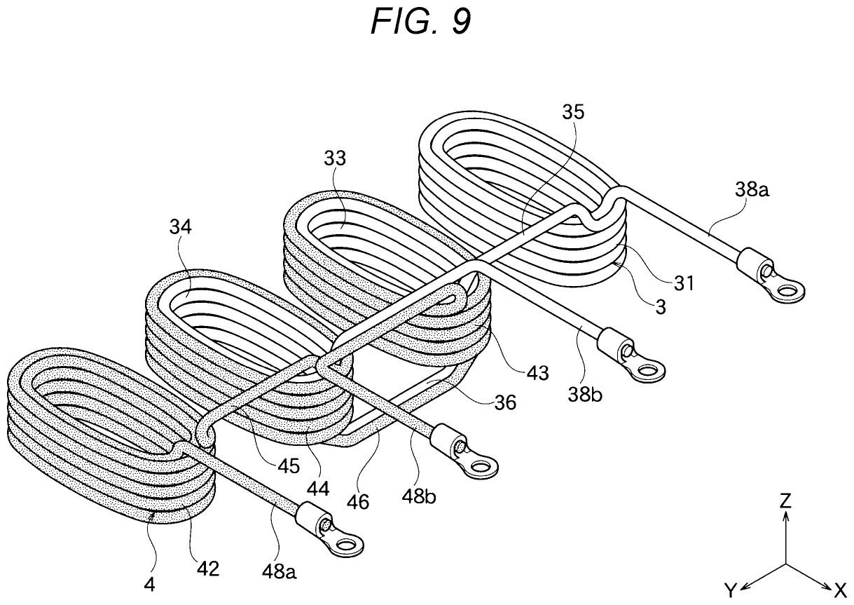

The third bobbin 2c and the fourth bobbin 2d are disposed between the first bobbin 2a and the second bobbin 2b. More specifically, the third bobbin 2c is disposed between the first bobbin 2a and the fourth bobbin 2d, and the fourth bobbin 2d is disposed between the third bobbin 2c and the second bobbin 2b. The cores attached to the fourth bobbin 2d have the same configuration as the core 5a1 and others, and are attached to the fourth bobbin 2d from one side and the other side in its axial direction. As illustrated in FIGS. 8 and 9, the first wire 3 is wound around the fourth bobbin 2d to form the fourth primary coil 34, and the second wire 4 is wound around the fourth bobbin 2d to form the fourth secondary coil 44. The fourth secondary coil 44 is disposed (stacked) on the fourth primary coil 34.

When the third secondary coil 43 is stacked on the third primary coil 33 on the third bobbin 2c, the fourth secondary coil 44 is stacked on the fourth primary coil 34 on the fourth bobbin 2d. On the other hand, when the third primary coil 33 is stacked on the third secondary coil 43 on the third bobbin 2c, the fourth primary coil 34 is stacked on the fourth secondary coil 44 on the fourth bobbin 2d.

The fourth primary coil 34 and the fourth secondary coil 44 are not particularly limited, but are each formed in five layers along their winding axis direction. The fourth primary coil 34 and the fourth secondary coil 44 are not particularly limited, but are each formed in one layer along their radial direction. The fourth primary coil 34 constitutes a primary coil of a transformer formed on the fourth bobbin 2d, and functions as a transformer portion of the coil device 1A. The fourth secondary coil 44 constitutes a secondary coil of a transformer formed on the fourth bobbin 2d, and functions as a transformer portion of the coil device 1A. The winding ratio between the fourth primary coil 34 and the fourth secondary coil 44 is 1:1.

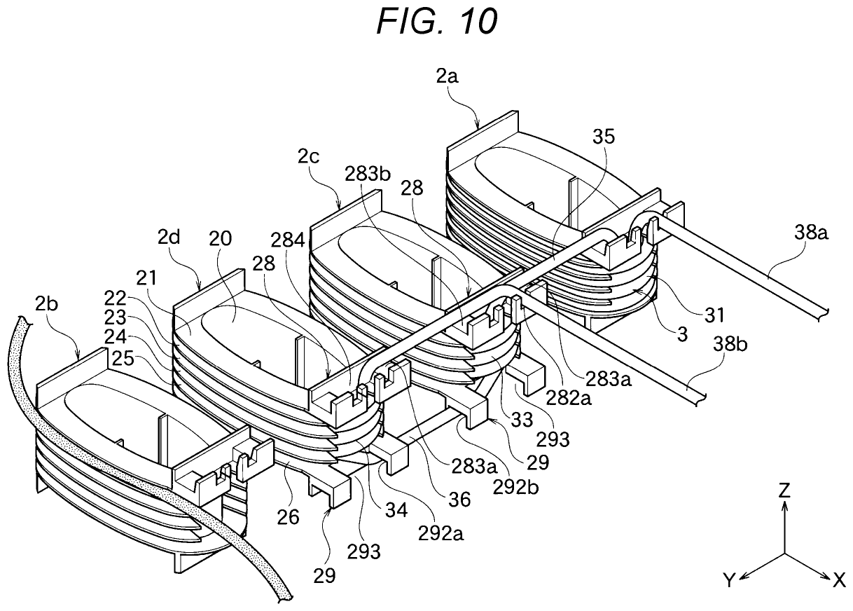

As illustrated in FIG. 10, the first wire 3 is continuously wound around the first bobbin 2a, the third bobbin 2c, and the fourth bobbin 2d in this order. The winding form of the first wire 3 from the first bobbin 2a to the third bobbin 2c in the present embodiment is similar to the winding form of the first wire 3 from the first bobbin 2a to the third bobbin 2c in the first embodiment. Therefore, the winding form of the first wire 3 around the fourth bobbin 2d after the first wire 3 is wound around the first bobbin 2a and the third bobbin 2c is described below.

On the fourth bobbin 2d, the first wire 3 is wound from the lower end of the fourth bobbin 2d, that is, the region between the flange portion 25 and the flange portion 26. The first wire 3 is then wound around the outer circumferential surface of the cylindrical portion 20 from the lower end toward the upper end of the fourth bobbin 2d. Thus, the fourth primary coil 34 including one layer is formed on the fourth bobbin 2d along its radial direction.

As illustrated in FIG. 8, the second wire 4 is continuously wound around the second bobbin 2b, the fourth bobbin 2d, and the third bobbin 2c in this order. The winding form of the second wire 4 from the second bobbin 2b to the fourth bobbin 2d in the present embodiment is similar to the winding form of the second wire 4 from the second bobbin 2b to the third bobbin 2c in the first embodiment. Therefore, the winding form of the second wire 4 around the third bobbin 2c after the second wire 4 is wound around the second bobbin 2b and the fourth bobbin 2d is described below.

On the third bobbin 2c, the second wire 4 is wound from the lower end of the third bobbin 2c, that is, the region between the flange portion 25 and the flange portion 26. The second wire 4 is then wound around the outer circumferential surface of the cylindrical portion 20 from the lower end toward the upper end of the third bobbin 2c. As a result, the third secondary coil 43 including one layer is formed on the third primary coil 33 (see FIG. 10) on the third bobbin 2c along its radial direction.

The leadout form of the connection 35 in the present embodiment is similar to the leadout form of the connection 35 in the first embodiment. The leadout form of the connection 45 in the present embodiment is similar to the leadout form of the connection 45 in the first embodiment. Therefore, the leadout form of the connections 36 and 46 is described below.

As illustrated in FIG. 10, the connection 36 continuously connects one end (lower end) of the third primary coil 33 in the axial direction and one end (lower end) of the fourth primary coil 34 in the axial direction. On the third bobbin 2c, the connection 36 passes through the space 293 of the wire insertion portion 29 and descends from the outer circumferential surface of the lower end (lowermost layer turn) of the third primary coil 33 located between the flange portion 25 and the flange portion 26.

The connection 36 passes through the leadout passage 292a of the fourth bobbin 2d along the Y axis and passes through the leadout passage 292b of the third bobbin 2c along the Y axis. The connection 36 is linearly drawn out along the Y axis between the leadout passage 292b of the third bobbin 2c and the leadout passage 292a of the fourth bobbin 2d, but may be bent or curved in the middle.

On the fourth bobbin 2d, the connection 36 is raised toward the outer circumferential surface of the lower end (lowermost layer turn) of the fourth primary coil 34 located between the flange portion 25 and the flange portion 26 while passing through the space 293 of the wire insertion portion 29.

As illustrated in FIG. 8, the connection 46 continuously connects the other end (lower end) of the fourth secondary coil 44 in the axial direction and the other end (lower end) of the third secondary coil 43 in the axial direction. On the fourth bobbin 2d, the connection 46 passes through the space 293 of the wire insertion portion 29 and descends from the outer circumferential surface of the lower end (lowermost layer turn) of the fourth secondary coil 44 located between the flange portion 25 and the flange portion 26.

The connection 46 passes through the leadout passage 292a of the fourth bobbin 2d along the Y axis and passes through the leadout passage 292b of the third bobbin 2c along the Y axis. The connection 46 is linearly drawn out along the Y axis between the leadout passage 292a of the fourth bobbin 2d and the leadout passage 292b of the third bobbin 2c, but may be bent or curved in the middle.

On the third bobbin 2c, the connection 46 is raised toward the outer circumferential surface of the lower end (lowermost layer turn) of the third secondary coil 43 located between the flange portion 25 and the flange portion 26 while passing through the space 293 of the wire insertion portion 29.

The leadout form of the first leadout portion 38a in the present embodiment is similar to the leadout form of the first leadout portion 38a in the first embodiment. As illustrated in FIG. 10, the first leadout portion 38b is raised from the outer circumferential surface of the fourth primary coil 34 while passing through the space 284 of the leadout fixing portion 28 on the fourth bobbin 2d. The first leadout portion 38b passes through the leadout passage 283a of the fourth bobbin 2d along the Y axis and passes through the leadout passage 283b of the third bobbin 2c along the Y axis. On the third bobbin 2c, the first leadout portion 38b is drawn outward along the X axis from the leadout fixing portion 28 while passing through the groove portion 282a of the leadout fixing portion 28.

As illustrated in FIG. 8, the leadout form of the second leadout portion 48a in the present embodiment is similar to the leadout form of the second leadout portion 48a in the first embodiment. On the third bobbin 2c, the second leadout portion 48b is raised from the outer circumferential surface of the third secondary coil 43 while passing through the space 284 of the leadout fixing portion 28. The second leadout portion 48b passes through the leadout passage 283b of the third bobbin 2c along the Y axis and passes through the leadout passage 283a of the fourth bobbin 2d along the Y axis. The second leadout portion 48b is drawn outward along the X axis from the leadout fixing portion 28 while passing through the groove portion 282b of the leadout fixing portion 28 on the fourth bobbin 2d.

As illustrated in FIG. 9, in the present embodiment, the first coil 31 is wound clockwise, the third primary coil 33 is wound clockwise, and the fourth primary coil 34 is wound counterclockwise. The second coil 42 is wound clockwise, the fourth secondary coil 44 is wound counterclockwise, and the third secondary coil 43 is wound clockwise. However, the winding direction of these coils is not limited to the winding direction illustrated in FIG. 9.

Also in the present embodiment, the same effects as those of the first embodiment can be obtained. In addition, in the present embodiment, as illustrated in FIGS. 8 and 10, the first wire 3 is wound around the fourth bobbin 2d to form the fourth primary coil 34, and the second wire 4 is wound around the fourth bobbin 2d to form the fourth secondary coil 44. Therefore, a transformer portion can be formed by the fourth primary coil 34 and the fourth secondary coil 44 formed on the fourth bobbin 2d, and an electric circuit (resonant circuit or the like) including two inductor portions and two transformer portions can be configured by two continuous wires.

In addition, when the first wire 3 is wound around the first bobbin 2a, the third bobbin 2c, and the fourth bobbin 2d to form the first coil 31, the third primary coil 33, and the fourth primary coil 34, respectively, these coils are continuous, and no discontinuity due to a terminal or the like is formed between these coils. Therefore, the first wire 3 is simply routed between these coils, and the reliability of the coil device 1A is improved. Further, the electrical properties (copper loss and the like) of the first coil 31, the third primary coil 33, or the fourth primary coil 34 are not deteriorated due to discontinuities such as terminals.

When the second wire 4 is wound around the second bobbin 2b, the fourth bobbin 2d, and the third bobbin 2c to form the second coil 42, the fourth secondary coil 44, and the third secondary coil 43, respectively, these coils are continuous, and no discontinuity due to a terminal or the like is formed between these coils. Therefore, the second wire 4 is simply routed between these coils, and the reliability of the coil device 1A is improved. Further, the electrical properties (copper loss and the like) of the second coil 42, the fourth secondary coil 44, or the third secondary coil 43 are not deteriorated due to discontinuities such as terminals.

In addition, the first wire 3 is continuously wound around the first bobbin 2a, the third bobbin 2c, and the fourth bobbin 2d in this order, and the second wire 4 is continuously wound around the second bobbin 2b, the fourth bobbin 2d, and the third bobbin 2c in this order. By arranging the third bobbin 2c and the fourth bobbin 2d between the first bobbin 2a and the second bobbin 2b, the first wire 3 can be easily wound around the first bobbin 2a, the third bobbin 2c, and the fourth bobbin 2d in this order. Further, the second wire 4 is easily wound around the second bobbin 2b, the fourth bobbin 2d, and the third bobbin 2c in this order. Therefore, the third primary coil 33 can be easily formed on the third bobbin 2c, and the fourth primary coil 34 can be easily formed on the fourth bobbin 2d. Further, the third secondary coil 43 can be easily formed on the third bobbin 2c, and the fourth secondary coil 44 can be easily formed on the fourth bobbin 2d. As a result, a transformer portion can be easily formed on each of the third bobbin 2c and the fourth bobbin 2d.

The third secondary coil 43 is stacked on the third primary coil 33, and the fourth secondary coil 44 is stacked on the fourth primary coil 34. Therefore, first, the first wire 3 can be continuously wound around the first bobbin 2a, the third bobbin 2c, and the fourth bobbin 2d in this order, and then the second wire 4 can be continuously wound around the second bobbin 2b, the fourth bobbin 2d, and the third bobbin 2c in this order. Therefore, the winding operation of the first wire 3 and the second wire 4 is easy.

### Third Embodiment

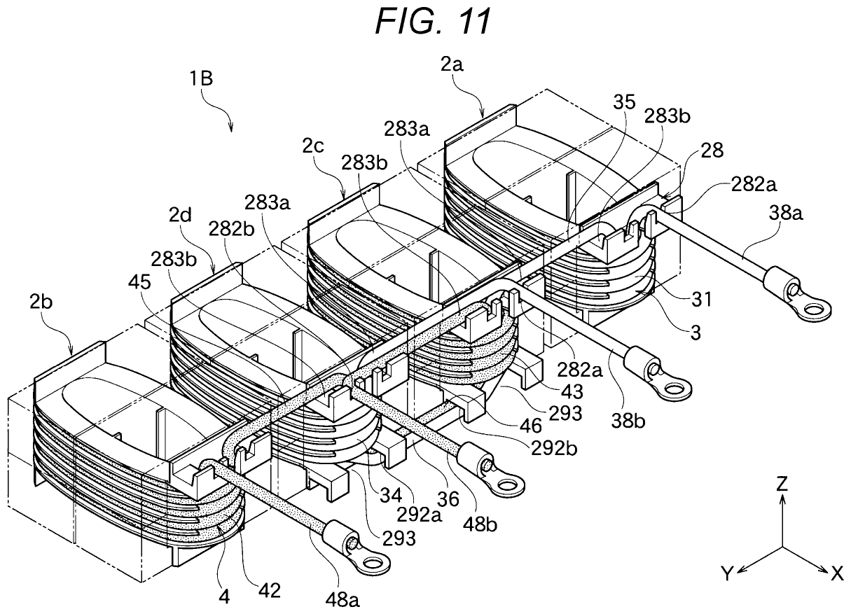

The coil device 1B of the third embodiment illustrated in FIG. 11 has the same configuration as that of the coil device 1A of the second embodiment except for the following points. Portions overlapping with the coil device 1A of the second embodiment are denoted by the same reference numerals, and their detailed description is omitted.

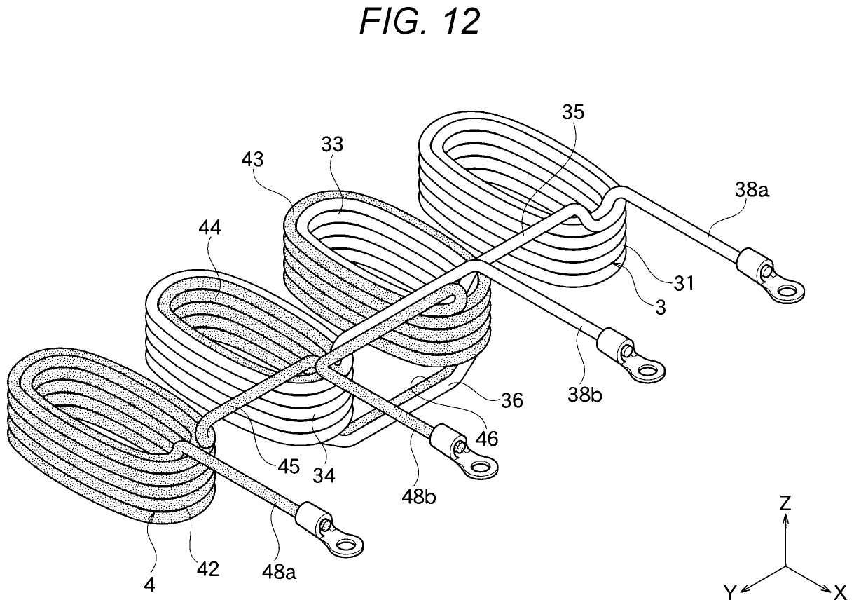

As illustrated in FIGS. 11 and 12, the third secondary coil 43 is stacked on the third primary coil 33 on the third bobbin 2c. Further, the fourth primary coil 34 is stacked on the fourth secondary coil 44 on the fourth bobbin 2d. The leadout form of the first leadout portions 38a and 38b in the present embodiment is similar to the leadout form of the first leadout portions 38a and 38b in the second embodiment. In addition, the leadout form of the second leadout portions 48a and 48b in the present embodiment is similar to the leadout form of the second leadout portions 48a and 48b in the second embodiment.

The leadout form of the connections 35 and 36 in the present embodiment is similar to the leadout form of the connections 35 and 36 in the second embodiment. The leadout form of the connections 45 and 46 in the present embodiment is similar to the leadout form of the connections 45 and 46 in the second embodiment. The positions of the connection 36 and the connection 46 in this embodiment are swapped in the X axis direction with respect to their positions in the second embodiment. However, these positional relationships may be the same as those in the second embodiment.

The winding form of the first wire 3 and the second wire 4 illustrated in FIG. 11 can be obtained as follows. Hereinafter, the method for simultaneously winding the first wire 3 and the second wire 4 by a winding machine or the like is described. However, the winding operation of the first wire 3 and the second wire 4 may be performed at different times.

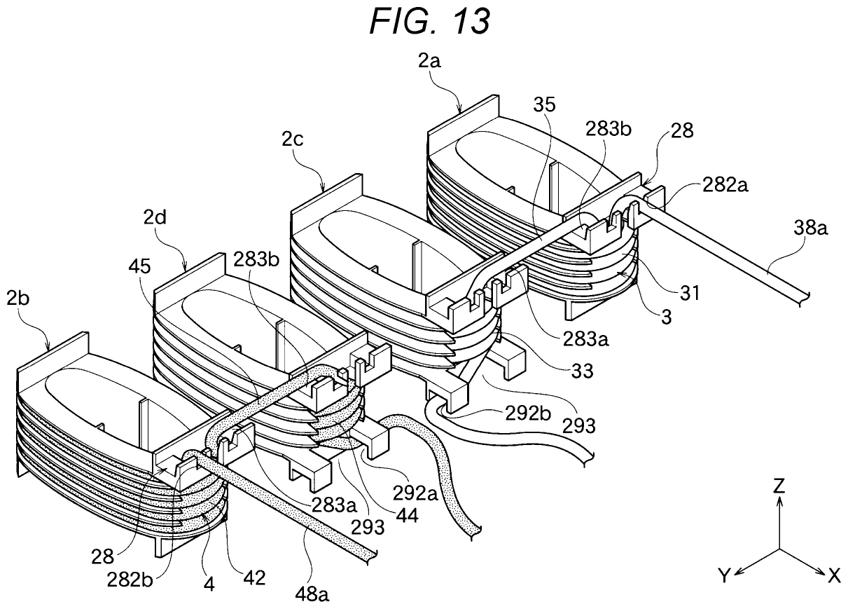

As illustrated in FIG. 13, first, the first wire 3 is wound around the first bobbin 2a so as to reciprocate from the upper side to the lower side, and further from the lower side to the upper side. Thus, the first coil 31 is formed on the first bobbin 2a. Subsequently, the first wire 3 (connection portion 35) is transferred from the first bobbin 2a to the third bobbin 2c, and the first wire 3 is wound around the third bobbin 2c from the upper side to the lower side. As a result, the third primary coil 33 is formed on the third bobbin 2c.

At the same time, the second wire 4 is wound around the second bobbin 2b so as to reciprocate from the upper side to the lower side, and further from the lower side to the upper side. Thus, the second coil 42 is formed on the second bobbin 2b. Subsequently, the second wire 4 (connection portion 45) is transferred from the second bobbin 2b to the fourth bobbin 2d, and the second wire 4 is wound around the fourth bobbin 2d from the upper side to the lower side. Thus, the fourth secondary coil 44 is formed on the fourth bobbin 2d.

Next, as illustrated in FIG. 11, the first wire 3 (connection portion 36) is transferred from the third bobbin 2c to the fourth bobbin 2d, and the first wire 3 is wound around the fourth bobbin 2d from the lower side to the upper side. Thus, the fourth primary coil 34 is formed on the fourth secondary coil 44 on the fourth bobbin 2d (FIG. 13). At the same time, the second wire 4 (connection 46) is transferred from the fourth bobbin 2d to the third bobbin 2c, and the second wire 4 is wound around the third bobbin 2c from the lower side to the upper side. As a result, the third secondary coil 43 is formed on the third primary coil 33 (FIG. 13) on the third bobbin 2c.

Next, the first wire 3 (first leadout portion 38b) is drawn out from the fourth bobbin 2d to the third bobbin 2c, and further, the first wire 3 (first leadout portion 38b) is drawn out outward in the X axis direction from the leadout fixing portion 28 through the groove portion 282a of the third bobbin 2c. At the same time, the second wire 4 (second leadout portion 48b) is drawn out from the third bobbin 2c to the fourth bobbin 2d, and the second wire 4 (second leadout portion 48b) is further drawn outward in the X axis direction from the leadout fixing portion 28 via the groove portion 282b of the fourth bobbin 2d. As described above, the winding form of the first wire 3 and the second wire 4 illustrated in FIG. 11 can be obtained.

As illustrated in FIG. 12, in the present embodiment, the first coil 31 is wound clockwise, the third primary coil 33 is wound clockwise, and the fourth primary coil 34 is wound counterclockwise. The second coil 42 is wound clockwise, the fourth secondary coil 44 is wound counterclockwise, and the third secondary coil 43 is wound counterclockwise. However, the winding direction of these coils is not limited to the winding direction illustrated in FIG. 12.

Also in the present embodiment, the same effects as those of the second embodiment can be obtained. In addition, as illustrated in FIGS. 11 and 12, in the present embodiment, the third secondary coil 43 is stacked on the third primary coil 33 on the third bobbin 2c, and the fourth primary coil 34 is stacked on the fourth secondary coil 44 on the fourth bobbin 2d. Therefore, first, the first wire 3 can be wound around the first bobbin 2a and the third bobbin 2c in this order to form the first coil 31 and the third primary coil 33 on the first bobbin 2a and the third bobbin 2c, respectively. At the same time, the second wire 4 can be wound around the second bobbin 2b and the fourth bobbin 2d in this order to form the second coil 42 and the fourth secondary coil 44, respectively. Next, the first wire 3 is wound around the fourth bobbin 2d on the fourth secondary coil 44 to form the fourth primary coil 34. Further, the second wire 4 can be wound around the third bobbin 2c on the third primary coil 33 to form the third secondary coil 43. As described above, the first wire 3 and the second wire 4 can be wound simultaneously, and the winding operation of the first wire 3 and the second wire 4 can be speeded up.

### Fourth Embodiment

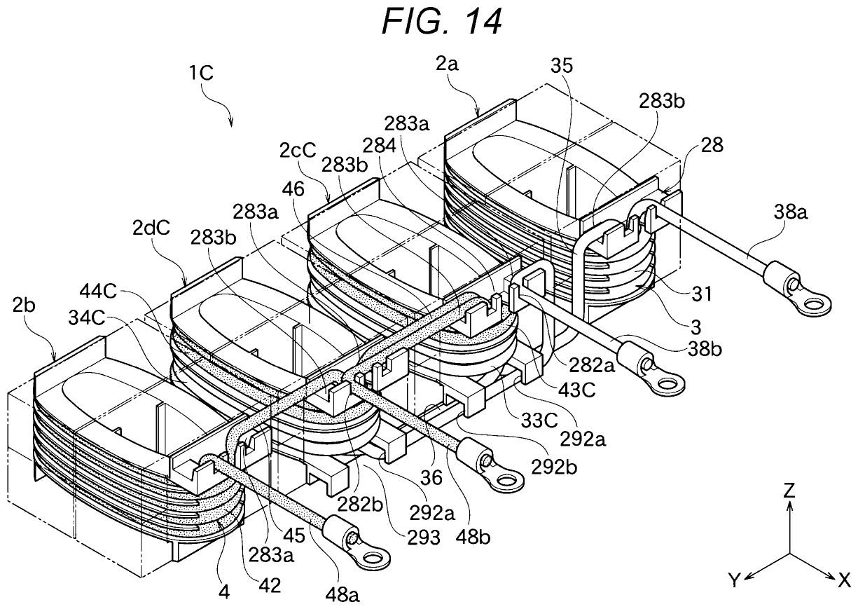

The coil device 1C of the fourth embodiment illustrated in FIG. 14 has the same configuration as that of the coil device 1A of the second embodiment except for the following points. Portions overlapping with the coil device 1A of the second embodiment are denoted by the same reference numerals, and their detailed description is omitted.

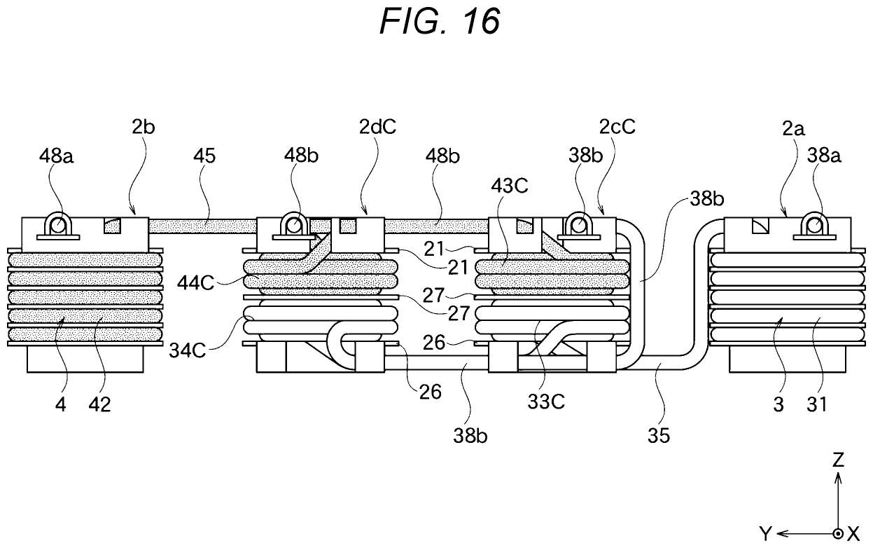

The coil device 1C includes a third bobbin 2cC and a fourth bobbin 2dC. As illustrated in FIG. 16, on the third bobbin 2cC, one flange portion 27 is formed between the flange portion 21 and the flange portion 26 on the outer circumferential surface of the cylindrical portion 20. On the fourth bobbin 2dC, one flange portion 27 is formed between the flange portion 21 and the flange portion 26 on the outer circumferential surface of the cylindrical portion 20.

As illustrated in FIG. 14, on the third bobbin 2cC, the third primary coil 33C and the third secondary coil 43C are disposed adjacent to each other along the axial direction of the third bobbin 2cC. On the fourth bobbin 2dC, the fourth primary coil 34C and the fourth secondary coil 44C are disposed adjacent to each other along the axial direction of the fourth bobbin 2dC.

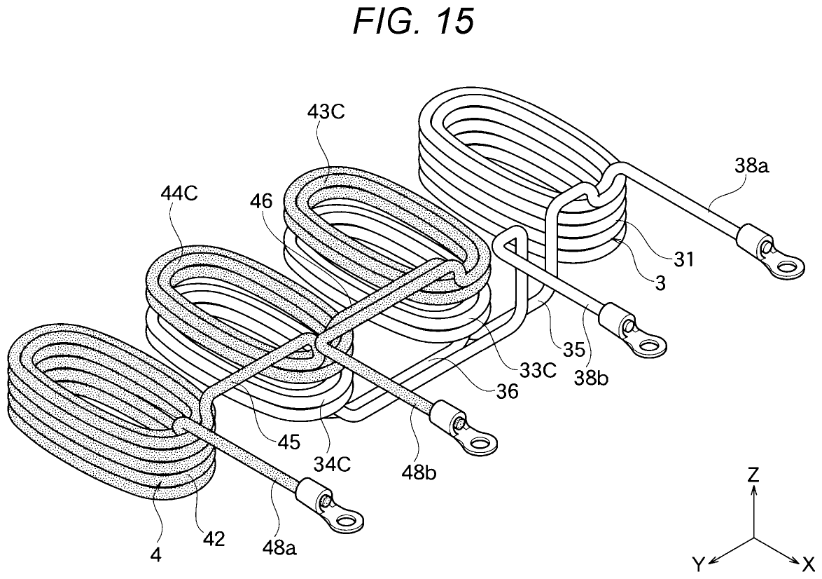

As illustrated in FIGS. 15 and 16, the third primary coil 33C is not particularly limited, but is formed in three layers along the winding axis direction in a region between the flange portion 26 and the flange portion 27 of the third bobbin 2cC. The third primary coil 33C is not particularly limited, but formed in two layers along its radial direction. The third secondary coil 43C is not particularly limited, but is formed in three layers along its winding axis direction in a region between the flange portion 21 and the flange portion 27 of the third bobbin 2cC. The third secondary coil 43C is not particularly limited, but formed in two layers along its radial direction. The third primary coil 33C and the third secondary coil 43C function as a transformer portion of the coil device 1C.

The fourth primary coil 34C is not particularly limited, but is formed in three layers along its winding axis direction in a region between the flange portion 26 and the flange portion 27 of the third bobbin 2dC. The fourth primary coil 34C is not particularly limited, but formed in two layers along its radial direction. The fourth secondary coil 44C is not particularly limited, but is formed in three layers along its winding axis direction in a region between the flange portion 21 and the flange portion 27 of the third bobbin 2dC. The fourth secondary coil 44C is not particularly limited, but formed in two layers along its radial direction. The fourth primary coil 34C and the fourth secondary coil 44C function as a transformer portion of the coil device 1C.

On the third bobbin 2cC, the third primary coil 33C is disposed below the third secondary coil 43C, but the third primary coil 33C may be disposed above the third secondary coil 43C. On the fourth bobbin 2dC, the fourth primary coil 34C is disposed below the fourth secondary coil 44C, but the fourth primary coil 34C may be disposed above the fourth secondary coil 44C.

Alternatively, on the third bobbin 2cC, the third secondary coil 43C may be disposed below the third primary coil 33C, and on the fourth bobbin 2dC, the fourth secondary coil 44C may be disposed above the fourth primary coil 34C. Alternatively, on the third bobbin 2cC, the third secondary coil 43C may be disposed above the third primary coil 33C, and on the fourth bobbin 2dC, the fourth secondary coil 44C may be disposed below the fourth primary coil 34C.

The winding form of the first wire 3 and the second wire 4 illustrated in FIG. 14 can be obtained as follows. Hereinafter, the method for simultaneously winding the first wire 3 and the second wire 4 by a winding machine or the like is described. However, the winding operation of the first wire 3 and the second wire 4 may be performed at different times.

As illustrated in FIG. 14, first, the first wire 3 is wound around the first bobbin 2a so as to reciprocate from the upper side to the lower side, and further from the lower side to the upper side. Thus, the first coil 31 is formed on the first bobbin 2a. The second wire 4 is wound around the second bobbin 2b so as to reciprocate from the upper side to the lower side, and further from the lower side to the upper side. Thus, the second coil 42 is formed on the second bobbin 2b.

Subsequently, the first wire 3 (connection portion 35) is transferred from the first bobbin 2a to the third bobbin 2cC. More specifically, the first wire 3 is inserted from the leadout passage 283b of the first bobbin 2a to the leadout passage 292a of the third bobbin 2cC. Then, the first wire 3 is wound in a reciprocating manner from the lower side to the upper side and further from the upper side to the lower side in a region between the flange portion 26 and the flange portion 27 of the third bobbin 2cC (see FIG. 16). As a result, the third primary coil 33C is formed on the third bobbin 2cC.

The second wire 4 (connection 45) is transferred from the second bobbin 2b to the fourth bobbin 2dC. More specifically, the second wire 4 is inserted from the leadout passage 283a of the second bobbin 2b to the leadout passage 283b of the fourth bobbin 2dC. Then, the second wire 4 is wound in a reciprocating manner from the upper side to the lower side and further from the lower side to the upper side in a region between the flange portion 21 and the flange portion 27 of the fourth bobbin 2dC (see FIG. 16). Thus, the fourth secondary coil 44C is formed on the fourth bobbin 2dC.

Subsequently, the first wire 3 (connection portion 36) is transferred from the third bobbin 2cC to the fourth bobbin 2dC. More specifically, the first wire 3 is inserted from the leadout passage 292b of the third bobbin 2cC to the leadout passage 292a of the fourth bobbin 2dC. Then, the first wire 3 is wound in a reciprocating manner from the lower side to the upper side and further from the upper side to the lower side in a region between the flange portion 26 and the flange portion 27 of the fourth bobbin 2dC (see FIG. 16). Thus, the fourth primary coil 34C is formed on the fourth bobbin 2dC.

The second wire 4 (connection portion 46) is transferred from the fourth bobbin 2dC to the third bobbin 2cC. More specifically, the second wire 4 is inserted from the leadout passage 283a of the fourth bobbin 2dC to the leadout passage 283b of the third bobbin 2cC. Then, the second wire 4 is wound in a reciprocating manner from the upper side to the lower side and further from the lower side to the upper side in a region between the flange portion 21 and the flange portion 27 of the third bobbin 2cC (see FIG. 16). As a result, the third secondary coil 43C is formed on the third bobbin 2cC.

Next, from the outer circumferential surface of the fourth primary coil 34C, the first wire 3 (first leadout portion 38b) is drawn out so as to pass through the space 293 of the fourth bobbin 2dC, the leadout passage 292a of the fourth bobbin 2dC, the leadout passage 292b of the third bobbin 2cC, the leadout passage 292a of the third bobbin 2cC, the leadout passage 283a of the third bobbin 2cC, and the groove portion 282a of the third bobbin 2cC in this order. In a region between the leadout passage 292a and the leadout passage 283a of the third bobbin 2cC, the first wire 3 is drawn out so as to rise. The first wire 3 is drawn out from the outer side toward the inner side along the Y axis in the leadout passage 283a of the third bobbin 2cC.

The second wire 4 (second leadout portion 48b) is drawn out from the outer circumferential surface of the third secondary coil 43C so as to pass through the space 284 of the third bobbin 2cC, the leadout passage 283b of the fourth bobbin 2dC, and the groove portion 282b of the fourth bobbin 2dC in this order. As described above, the winding form of the first wire 3 and the second wire 4 illustrated in FIG. 14 can be obtained.

As illustrated in FIG. 15, in the present embodiment, the first coil 31 is wound clockwise, the third primary coil 33C is wound clockwise, and the fourth primary coil 34C is wound clockwise. The second coil 42 is wound counterclockwise, the fourth secondary coil 44C is wound clockwise, and the third secondary coil 43C is wound clockwise. However, the winding direction of these coils is not limited to the winding direction illustrated in FIG. 15.

Also in the present embodiment, the same effects as those of the second embodiment can be obtained. In addition, in the present embodiment, the third primary coil 33C and the third secondary coil 43C are disposed adjacent to each other along the axial direction of the third bobbin 2cC, and the fourth primary coil 34C and the fourth secondary coil 44C are disposed adjacent to each other along the axial direction of the fourth bobbin 2dC. Therefore, the coupling between the third primary coil 33C and the third secondary coil 43C and the coupling between the fourth primary coil 34C and the fourth secondary coil 44C can be easily adjusted, and the magnetic properties of the coil device 1C can be easily optimized.

Note that the present invention is not limited to the above-described embodiments, and various modifications can be made within the scope of the present invention. For example, as shown in FIG. 6, in the first embodiment, the third secondary coil 43 is stacked on the third primary coil 33. However, the third primary coil 33 may be stacked on the third secondary coil 43.

In the first embodiment, the third primary coil 33 and the third secondary coil 43 may be disposed adjacent to each other along the axial direction of the third bobbin 2c. Also in this case, the coupling between the third primary coil 33 and the third secondary coil 43 can be easily adjusted, and the magnetic properties of the coil device 1 can be easily optimized.

As illustrated in FIGS. 8 and 9, in the second embodiment, the third secondary coil 43 is stacked on the third primary coil 33 on the third bobbin 2c, and the fourth secondary coil 44 is stacked on the fourth primary coil 34 on the fourth bobbin 2d. However, on the third bobbin 2c, the third primary coil 33 may be stacked on the third secondary coil 43, and on the fourth bobbin 2d, the fourth primary coil 34 may be stacked on the fourth secondary coil 44. In this case, first, the second wire 4 can be continuously wound around the second bobbin 2b, the fourth bobbin 2d, and the third bobbin 2c in this order, and then the first wire 3 can be continuously wound around the first bobbin 2a, the third bobbin 2c, and the fourth bobbin 2d in this order. Therefore, also in this case, the winding operation of the first wire 3 and the second wire 4 is easy.

In each of the above embodiments, as illustrated in FIG. 5, each of the cores 5a1 to 5a4 is configured as a split core, but for example, the core 5a1 and the core 5a2 may be integrated. Further, the core 5a3 and the core 5a4 may be integrated. In each of the above embodiments, an E-shaped core and an I-shaped core may be combined.

In each of the above embodiments, an L-shaped heat sink may be attached to the cores 5a1 and 5a2 illustrated in FIG. 5. The same applies to the cores 5b1 and 5b2, the same applies to the cores 5cl and 5c2, and the same applies to the cores 5d1 and 5d2 (FIG. 8).

In each of the above embodiments, the first bobbin 2a to the fourth bobbin 2d, together with cores, may be collectively accommodated in a case made of metal having excellent cooling properties such as aluminum. In addition, the inside of the case may be filled with a heat dissipation resin composed of a silicone resin, a urethane resin, an epoxy resin, or the like.

### REFERENCE SIGNS LIST

1, 1A, 1B, 1C Coil device
2a, 2b, 2c, 2d, 2cC, 2dC First bobbin to fourth bobbin
20 Cylindrical portion
200 Through hole
201 Projection
21 to 27 Flange portion
220, 230, 240, 250 Notch portion
27a, 27b, 27c, 27d Core fixing portion
28 Leadout fixing portion
280a, 280b Protrusion
281a, 281b Wall portion
282a, 282b Groove portion
283a, 283b Leadout passage
284 Space
29 Wire insertion portion
290a, 290b Protrusion
291a, 291b Wall portion
292a, 292b Leadout passage
293 Space
3 First wire
31 First coil
33, 33C Third primary coil
34, 34C Fourth primary coil
35,36 Connection
38a, 38b First leadout portion
4 Second wire
42 Second coil
43, 43C Third secondary coil
44, 44C Fourth secondary coil
45.46 Connection
48a, 48b Second leadout portion
5a1 to 5a4, 5b1 to 5b4, 5cl to 5c4, 5d1 to 5d3 Core
50 Base portion
51 Middle leg
52 Outer leg
6a to 6d Terminal

What is claimed is:

1. A coil device comprising:
bobbins;
a continuous first wire wound around the bobbins; and
a continuous second wire wound around the bobbins,
wherein the bobbins comprises a first bobbin, a second bobbin, and a third bobbin,
the first wire is wound around the first bobbin to form a first coil,
the second wire is wound around the second bobbin to form a second coil, and
the first wire is wound around the third bobbin to form a third primary coil and the second wire is wound around the third bobbin to form a third secondary coil.

2. The coil device according claim 1, wherein
the third bobbin is disposed between the first bobbin and the second bobbin,
the first wire is continuously wound from the first bobbin to the third bobbin, and
the second wire is continuously wound from the second bobbin to the third bobbin.

3. The coil device according to claim 1, wherein one of the third primary coil and the third secondary coil is stacked on an other of the third primary coil and the third secondary coil.

4. The coil device according to claim 1, wherein the third primary coil and the third secondary coil are disposed adjacent to each other along an axial direction of the third bobbin.

5. The coil device according to claim 1, wherein
the bobbins further comprise a fourth bobbin, and
the first wire is wound around the fourth bobbin to form a fourth primary coil, and the second wire is wound around the fourth bobbin to form a fourth secondary coil.

6. The coil device according to claim 5, wherein
The third bobbin and the fourth bobbin are disposed between the first bobbin and the second bobbin,
the first wire is continuously wound around the first bobbin, the third bobbin, and the fourth bobbin in this order, and
the second wire is continuously wound around the second bobbin, the fourth bobbin, and the third bobbin in this order.

7. The coil device according to claim 5, wherein
when the third secondary coil is stacked on the third primary coil on the third bobbin, the fourth secondary coil is stacked on the fourth primary coil on the fourth bobbin, and
when the third primary coil is stacked on the third secondary coil on the third bobbin, the fourth primary coil is stacked on the fourth secondary coil on the fourth bobbin.

8. The coil device according to claim 5, wherein the third secondary coil is stacked on the third primary coil on the third bobbin, and the fourth primary coil is stacked on the fourth secondary coil on the fourth bobbin.

9. The coil device according to claim 5, wherein
the third primary coil and the third secondary coil are disposed adjacent to each other along the axial direction of the third bobbin, and
the fourth primary coil and the fourth secondary coil are disposed adjacent to each other along the axial direction of the fourth bobbin.
